(19) United States
(12) Patent Application Publication
(10) Pub. No.: US 2004/0255646 A1
(43) Pub. Date: Dec. 23, 2004

(54) Method for control gas diffusion and bubble formation in liquid porosimetry

(76) Inventor: Valeriu Smiricinschi, Ithaca, NY (US)

Correspondence Address: VALERIU SMIRICINSCHI, 316 HIGHLAND RD., APT. B-204, ITHACA, NY, 94850, US

(21) Appl. No.: 10/462,890

(22) Filed: Jun. 17, 2003

(51) Int. Cl. G01N 15/08

(52) U.S. Cl. 73/38

(57) ABSTRACT

The main problem in liquid porosimetry) which prevents to see the pore sizes smaller than 2 microns in diameter, is direct gas diffusion flow through a micro-porous membrane. This diffusion causes bubbles formation on the bottom side of the membrane and that spoils extrusion (intrusion) data, as one cannot distinguish the volume of extrusion (intrusion) liquid from the volume of formatted bubbles. The suggested method cures the problem by creating the liquid flow below the membrane. The flow washes out all of the small bubbles preventing them to grow. That allows using the membrane at higher differential pressures, up to minimum bubble point of the membrane.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The present invention is related to the field of porosimetry, or the measurement of pore volume distribution within a porous material, particularly to the liquid (not mercury) extrusion or intrusion porosimeter.

In liquid extrusion porosimeter (LEP) liquid is forced out of the porous sample rather than into it, as in liquid intrusion porosimeter (LIP).

The basic arrangement for liquid porosimetry as introduced by Bernard Miller and Ilya Tyomkin [B. Miller, I. Tyomkin, “Liquid Porosimetry: New Methodology and Applications” Journal of colloidal and interface science 162, pp. 163-170 (1994)] is illustrated on FIG. 1. It can be used in both liquid extrusion porosimetry (LEP) and liquid intrusion porosimetry (LIP). For the LEP mode a presaturated sample is placed on a microporous membrane (if it is flexible, the membrane is supported by a rigid porous plate or by rigid support-screen). The diameter of pores of the sample must be less then diameter of pores of micro-porous membrane. The applied gas pressure P1 is increased in steps and that causes liquid to extrude from the pores of the sample. The largest pores extrude first. The top-loading balance for each pressure step measures the liquid volume out-coming from the sample. The final data for analyzes could be represented as a function relation V(DP), i.e. extruded volume versus differential pressure (DP=P1−P2). Assuming that all of the through-pores are cylindrical we can apply Laplace equation d=4g cos(q)/DP (here g is liquid surface tension, q is advanced or receding contact angle of the liquid and d is diameter of the pores) to convert the final data to the form V(d), i.e. volume versus diameter of the pores.

The same principal works for LIP mode, with the difference in starting at high pressure and decreasing it stepwise; and, of course, the sample is not initially saturated. Also LIP test can be run just after LEP test to see, for example, liquid extrusion-intrusion hysteresis.

Different liquids can be used in liquid porosimeter tests. The only requirements are: the liquid must wet the sample and membrane; the contact angle for the system of sample-liquid-gas must be known; liquid should be stable and should have relatively low viscosity. That is the basic principle of a liquid porosimetry test.

The basic scheme of liquid porosimetry allows testing pore sizes from 2000 to 2 micron in diameter. To see smaller pores the differential pressure should be increased. Also the smaller pores have smaller flow rate through and that requires a longer exposure-time for high pressure. Under these specific conditions the gas diffusion flow causes the major problem—the bubble formations below the membrane. The solubility of a gas in a liquid depends on pressure. Usually the more gas pressure is applied the more gas dissolves in the liquid. The dissolved under P1-pressure gas diffuses through sample and membrane into the P2-pressure area. But the solubility of a gas in P2-area is less then concentration of the defused gas. And that is the cause of the bubble formation on the bottom side of the the membrane. The volume of the bubbles cannot be distinguished from the volume of the liquid extruded from (intruded in) the sample and that spoils the final data when one tries to see the smallest pores.

These problems have been discussed in the article V. Smirichinski “Method for control gas diffusion and bubble formation in liquid porosimetry” presented at “Symposium: In Memory of Dr. Bernie Miller”, Princeton, N.J., USA, Nov. 20-21, 2002 and also published on Jul. 8, 2002 at //lanl.arXiv.org/physics/0207030.

### BRIEF SUMMARY OF THE INVENTION

To solve the problem of the gas diffusion bubble formation I suggest a method of controlling gas diffusion and bubble formation in liquid porosimetry. The essence of the method is the creation of the liquid-flow bellow the membrane to wash out the gas bubbles into the fluid displacement reservoir where they dissipate during the test and do not affect balance measurement.

### BRIEF DESCRIPTION OF THE SEVERAL VIEWS OF THE DRAWING

FIG. 1 shows basic arrangement of liquid porosimeter as known in prior art.

FIG. 2 shows basic arrangement of the present invention.

FIG. 3a shows detailed scheme of the sample chamber.

FIG. 3b shows the top view of the support to screen-support.

FIG. 3c shows the sectional view of the support to screen-support.

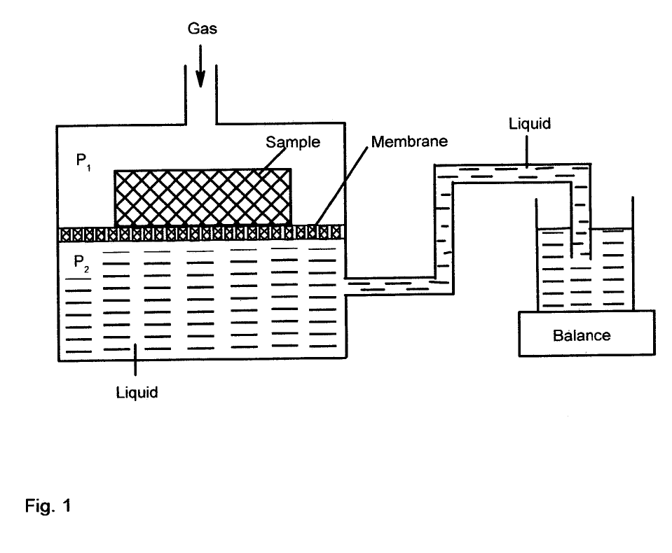

### DETAILED DESCRIPTION OF THE INVENTION

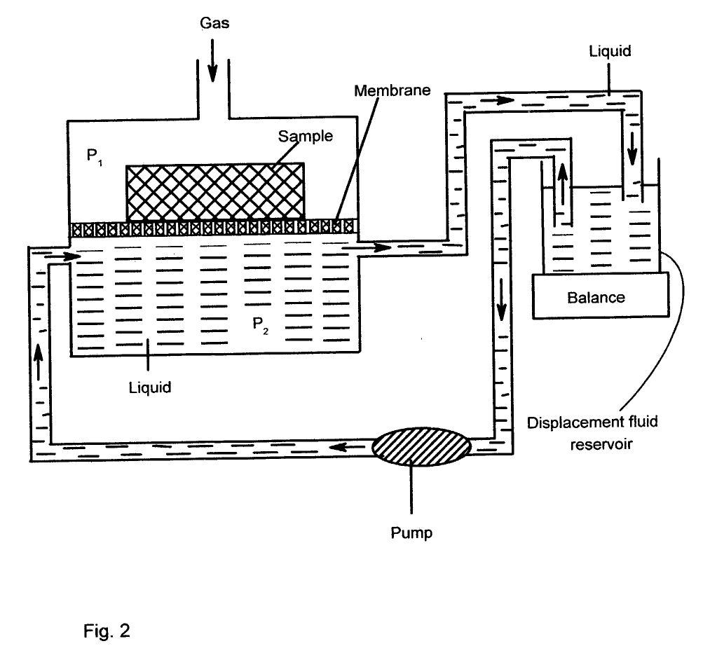

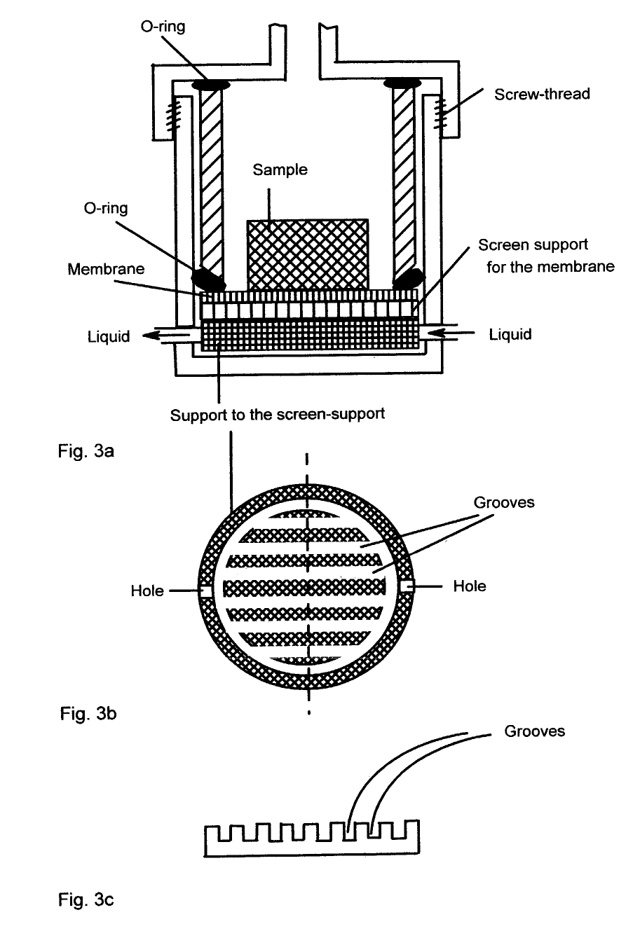

To solve the problem of the gas diffusion bubble formation I suggest a method of controlling gas diffusion and bubble formation in liquid porosimetry. The essence of the method is the creation of the liquid-flow bellow the membrane to wash out the gas bubbles during the test. On FIG. 2 the basics arrangement of the method is shown. On FIG. 3 the detailed scheme of the sample chamber is presented.

The actual realization of the method is the following: The sample is placed on a membrane. A membrane is placed on thin rigid screen support (I used Millipore 47 mm SST support screen). To prevent the deformation of the screen under the pressure another support (support to the screen-support) is placed under the first screen-support. The last one contains parallel grooves to direct the liquid flow (see FIG. 3) and two holes for incoming and out-coming tubes. Two O-rings provide the sealing in the sample chamber.

The pump creates the constant flow of the liquid below the membrane during the test. The recirculation flow is shown schematically by arrows on the FIG. 2. That flow is the main difference from the liquid porosimeter known in the previous art.

I used Fisher brand Variable-Flow Peristaltic Pump with ability to regulate the liquid flow from 4.0 up to 85.0 mL/min. During the test the pump is on constantly. The bubbles wash out into the displacement fluid reservoir, where they dissipate. For the recirculation flow in the system any pump can be used with the following requirements: stable flow rate during several ours of constant working, low rate of introducing bubbles into the system (less then 0.1 cc/min).

1. What is claimed is the method for control gas diffusion and bubble formation in liquid porosimetry which is the created fluid recirculation flow that removes away bubbles from bottom side of the membrane to the reservoir where the bubbles dissipate without affecting measurements.
